(19) United States
(12) Patent Application Publication
(10) Pub. No.: US 2008/0215774 A1
(43) Pub. Date: Sep. 4, 2008

(54) Wireless Universal Serial Bus Dual Role Device

(76) Inventors: Hae Jin Kim, Gyeonggi-do (KR); Sung Ho Cho, Seoul (KR); Dae Hyung Cho, Seoul (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/019,265

(22) Filed: Jan. 24, 2008

(30) Foreign Application Priority Data
Jan. 26, 2007 (KR) 10-2007-0008590

(51) Int. Cl. G06F 13/12

(52) U.S. Cl. 710/62

(57) ABSTRACT

Disclosed herein is a wireless universal serial bus (USB) dual role device (DRD) system in which a common part shared between a wireless USB host and a wireless USB device is extracted from a central processing unit (CPU) to implement a wireless USB DRD, and driven to be divisionally processed in the CPU according to roles to reduce system load, so that a DRD performance can be improved.

### TECHNICAL FIELD

The present invention relates to a wireless universal serial bus (USB) dual role device (DRD) system, and more particularly to a wireless USB DRD) system, in which a common part shared between a wireless USB host and a wireless USB device is extracted from a central processing unit (CPU) to implement a wireless USB DRD and is driven to allow distributed processing independent of the CPU according to roles to reduce system load, thereby improving DRD performance.

### BACKGROUND

In general, a universal serial bus (USB) is a kind of serial port designed to solve problems of low speed and limited device connectivity involved in existing external expansion ports (serial or parallel), and is a plug-and-play interface for connection between a computer and peripherals such as an audio player, a joystick, a keyboard, a telephone, a scanner, a printer, and the like.

As compared to the external expansion ports used for exclusive connection of devices including a modem, a printer, a scanner, etc., the USB enables simultaneous connection of peripheral devices such as a keyboard, a monitor, a mouse, a printer, a modem, and the like, which differ from one another in a connection manner. Hence, use of only a single USB connector enables a personal computer (PC) to connect with a maximum of one hundred twenty seven peripheral devices through display chaining.

Further, in an effort to remove a USB cable for connection between a computer system and external peripheral devices, a wireless USB (WUSB) has recently been standardized based on ultra wide band (UWB) technology. Wireless USB is designed to support a transfer rate approaching USB version 2.0 (e.g., 480 Mbps at the maximum) within a maximum distance of 10 m.

Such a wireless USB apparatus includes a wireless USB host capable of generating and managing a wireless USB channel, and a wireless USB device capable of connecting with the wireless USB host to transmit/receive data. The wireless USB host serves as a master, and the wireless USB device serves as a slave.

In an existing wired USB environment, cables are used for connecting the USB host to the USB devices, so that physical data transmission paths are formed around the USB host.

In this environment, data has to pass through the USB host when transferred between the USB devices. Likewise, since the wireless USB technology is based on wired USB technology, data transmission between the wireless USB devices is performed through the wireless USB host.

FIG. 1 is a block diagram of a conventional wireless USB system.

In this figure, a wireless USB device A 13 and a wireless USB device B 15 are connected to a single wireless USB host 11 for data transmission there between.

For example, if the wireless USB host 11 is a personal computer and the wireless USB devices A and B 13 and 15 are mobile storage devices, data is copied or transferred from the wireless USB device A 13 to the wireless USB device B 15, as follows.

First the wireless USB device A 13 transmits data to the wireless USB host 11. When the data is completely transmitted to the USB host 11, the wireless USB host 11 transmits the received data to the wireless USB device B 15.

Through these processes, the data is transmitted from the wireless USB device A 13 to the wireless USB device B 15. However, since the same data is transmitted twice through wireless network, data transmission is inefficient.

Thus, in order to increase data transmission efficiency of the wireless USB system, direct data transmission from the wireless USB device 13 to the wireless USB device B 15 has been proposed.

Similar to a USB On-The-Go (OTG) standard, a dual role device (DRD) has been proposed in the wireless USB system.

The DRD refers to a wireless USB device capable of executing both functions of the wireless USB host and the wireless USB device. However, the wireless USB host function and the wireless USB device function of the DRD are not performed at the same time. In other words, the DRD serves as the wireless USB host in a certain time period and serves as the wireless USB device in another certain time period, thereby achieving the data transmission between the wireless USB devices.

In realizing the DRD function, the CPU implements scheduling operations for roles of the wireless USB host and the wireless USB device, respectively, thereby controlling the DRD to play dual roles of both function of a host and function of a device.

Further, when the CPU manages a micro-scheduled management command (MMC) packet and processes a device notification (DN) packet, the CPU load increases, which deteriorates overall system performance.

### SUMMARY OF THE INVENTION

The present invention is conceived to solve the problems of the conventional techniques as described above, and an aspect of the present invention is to provide a wireless USB DRD system in which a common part shared between a wireless USB host and a wireless USB device is extracted from a central processing unit (CPU) to implement a wireless USB DRD, and is driven to allow distributed processing independent of the CPU according to roles to reduce system load, thereby improving DRD performance.

In accordance with one aspect of the present invention, the above and other objects can be accomplished by the provision of a wireless USB DRD system playing dual roles of a wireless USB host and a wireless USB device, which includes: a CPU having a host driver for driving as the role of the wireless USB host and a device driver for driving as the role of the wireless USB device; and a wireless USB DRD controller connected to the CPU through a system bus and accessing a physical layer to extract a channel allocation message and setup information from a micro-scheduled management command (MMC) packet input from the system bus or the physical layer such that the wireless USB Did) controller can be activated to play the role of the host along with the host driver or activated to play the role of the device along with the device driver according to role control and schedule information of the extracted channel allocation message.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram of a conventional wireless USB system;

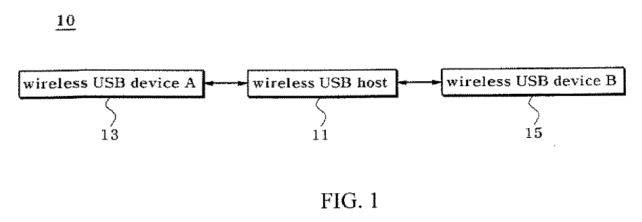

FIG. 2 is a block diagram of a wireless USB DRD system according to an exemplary embodiment of the present invention; and

FIG. 3 is a graph showing an output waveform of a role controller in the wireless USB DRD system according to an exemplary embodiment of the present invention.

### DETAILED DESCRIPTION

An aspect of the present invention is to provide a wireless USB DRD system in which a common part shared between a wireless USB host and a wireless USB device is extracted from a CPU to implement a wireless USB DRD, and driven to be divisionally processed in the CPU according to roles to reduce system load, so that DRD performance can be improved.

To accomplish the foregoing aspect, the present invention provides a wireless USB DRD system playing dual roles of a wireless USB host and a wireless USB device, which includes: a CPU having a host driver for driving as the role of the wireless USB host and a device driver for driving as the role of the wireless USB device; and a wireless USB DRD controller connected to the CPU through a system bus and accessing a physical layer to extract a channel allocation message and setup information from a micro-scheduled management command (MMC) packet input from the system bus or the physical layer such that the wireless USB DRD controller can be activated to play the role of the host along with the host driver or activated to play the role of the device along with the device driver according to role control and schedule information of the extracted channel allocation message.

According to one exemplary embodiment of the present invention, the wireless USB DRD controller includes a role controller which outputs a role signal for controlling the wireless USB DRD system to play the role of the host or the device for a predetermined period of time; an MMC controller which extracts and outputs the channel allocation message and the setup information from the MMC packet output from the host driver or an EP controller according to the role signal output from the role controller; a schedule controller which receives the channel allocation message from the MMC controller and the role signal from the role controller to control transmission/reception schedules; the EP controller which accesses the physical layer to control transmission/reception of user data and a device notification (DN) packet according to the role signal from the role controller and a control signal from the schedule controller; and a DN packet controller which sends the DN packet output from the EP controller to the host driver and sends the DN packet output from the device driver to the EP controller according to the role signal of the role controller.

In this configuration according to the present invention, with only a block for playing the role of the wireless USB host and a minimum number of drivers for playing the role of the wireless USB device included in the CPU, similar functions between the roles of the host and the device are extracted from the CPU and configured as a common block to allow distributed processing independent of the CPU, thereby decreasing CPU load to improve system performance.

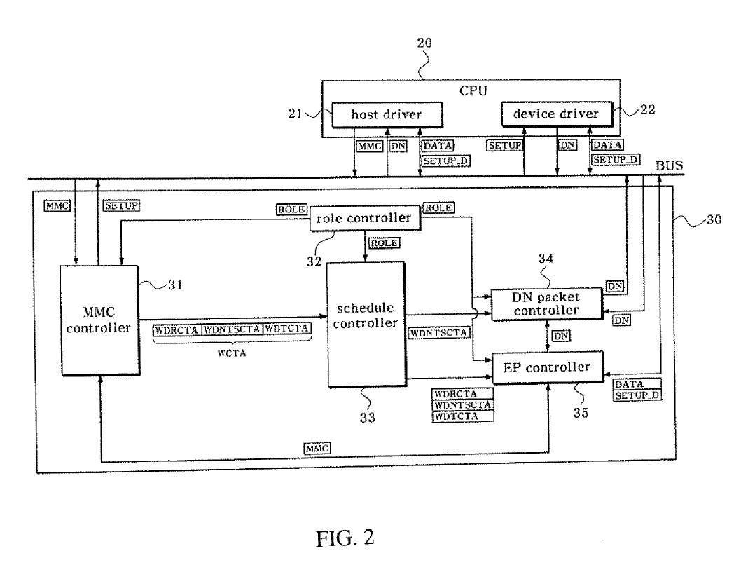

FIG. 2 is a block diagram of a wireless USB DRD system according to an exemplary embodiment of the present invention.

In FIG. 2, a wireless USB DRD system playing dual roles of a wireless USB host and a wireless USB device includes: a CPU 20 having a host driver 21 for driving as the role of the wireless USB host and a device driver 22 for driving as the role of the wireless USB device; and a wireless USB DRD controller 30 connected to the CPU 20 through a system bus BUS and accessing a physical layer (not shown) to extract a channel allocation message WCTA and setup information SETUP from an MMC packet input from the system bus BUS or the physical layer such that the wireless USB DRD controller 30 can be activated to play the role of the host along with the host driver 21 or activated to play the role of the device along with the device driver 22 according to role control and schedule information of the extracted channel allocation message WCTA.

The wireless USB DR) controller 30 includes a role controller 32 which outputs a role signal ROLE for controlling the wireless USB DRD system to play the role of the host or the device for a predetermined period of time; an MMC controller 31 which extracts and outputs the channel allocation message WCTA and the setup information SETUP from the MMC packet output from the host driver 21 or an EP controller 35 according to the role signal ROLE output from the role controller 32; a schedule controller 33 which receives the channel allocation message WCTA from the MMC controller 31 and the role signal ROLE from the role controller 32 to control transmission/reception schedules; the EP controller 35 which accesses the physical layer to control transmission/reception of user data DATA and a Device Notification(DN) packet according to the role signal ROLE from the role controller 32 and a control signal from the schedule controller 33; and a DN packet controller 34 which sends the DN packet output from the EP controller 35 to the host driver 21 and sends the DN packet output from the device driver 22 to the EP controller 35 according to the role signal ROLE of the role controller 32.

Hereinafter will be described operation of the wireless USB DRD system in detail.

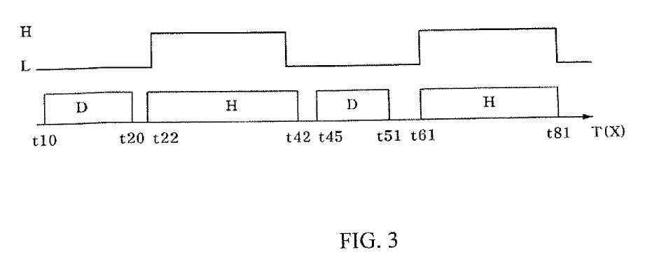

First, the role controller 32 outputs the role signal ROLE for the control to play the role of the host or the device for a predetermined period of time. As shown in FIG. 3, if the role signal ROLE is ‘high,’ the role of the host is played. On the other hand, if the role signal ROLE is ‘low,’ the role of the device is played.

The MMC controller 31 extracts the channel allocation message WCTA from the MMC packet output from the host driver 21 while the role of the host is implemented or output from the EP controller 35 while the role of the device is implemented according to the role signal ROLE output from the role controller 32, thereby sending the extracted channel allocation message WCTA to the schedule controller 33. If the MMC packet contains the setup information SETUP, the MMC controller 31 generates a setup interrupt and sends the setup interrupt to the device driver 22 through the system bus. Further, if the MMC packet contains other information, the MMC controller 31 performs a process corresponding to the information.

The schedule controller 33 receives the channel allocation message WCTA from the MMC controller 31 and the role signal ROLE from the role controller 32, and controls the transmission/reception schedules, thereby controlling operations of the EP controller 35 and the DN packet controller 34.

In other words, data transmission/reception is performed in response to the channel allocation message WCTA that is contrarily altered in meaning dependent on the roles of the host and the device by the role signal ROLE, as shown in Table 1.

TABLE 1

| | Role of Host | Role of Device |
|---|---|---|
| WDRCTA | Data Transmission | Data Reception |
| WDNTSCTA | DN packet Reception | DN packet Transmission |
| WDTCTA | Data Reception | Data Transmission |

When implementing the role of the wireless USB host, scheduling is controlled in such a way that data is transmitted from the wireless USB host to the wireless USB device in a Wireless USB Device Receive Channel Time Allocation (WDRCTA); the DN packet is received from the wireless USB device and processed in a Wireless USB Device Notification Channel Time Allocation (WDNTSCTA); and data is received from the wireless USB device and processed in a Wireless USB Transmit Channel Time Allocation (WDTCTA).

On the other hand, when implementing the role of the wireless USB device, the scheduling is controlled in such a way that data is received from the wireless USB host and processed in the WDRCTA; the DN packet is transmitted to the wireless USB host in the WDNTSCTA; and data is transmitted to the wireless USB host in the WDTCTA.

Here, the DN packet indicates a state of the device. In the case of playing the role of the host, the DN packet controller 34 sends the DN packet received from the EP controller 35 to the host driver 21 through the system bus BUS. On the other hand, in the case of playing the role of the device, the DN packet controller 34 receives the DN packet from the device driver 22 through the system bus BUS or generates the DN packet by itself to be sent through the EP controller 35.

The EP controller 35 controls data transmission between the physical layer and the host or device driver 21 or 22 of the CPU 20 according to scheduling information of the schedule controller 33 when either role of the host or device is performed on the basis of the role signal ROLE, as shown in Table 1.

Accordingly, the wireless USB DRD system plays the role of the host as follows.

First, the host driver 21 of the CPU 20 generates and sends the MMC packet to the MMC controller 31. When receiving the MMC packet, the MMC controller 31 extracts information relating to the channel allocation message WCTA from the MMC packet and sends this information to the schedule controller 33 to activate the schedule controller 33 at the same time.

The DN packet controller 34 waits for the DN packet from the EP controller 35 and sends the DN packet to the host driver 21 when determining that the DN packet is input.

The host driver 21 generates the setup information to be sent from the wireless USB host to the wireless USB device. If setup data SETUP_D to be sent to the wireless USB device is present, the host driver 21 transmits the setup data SETUP_D to the EP controller 35. Here, the host driver 21 inserts the setup information, generated when generating the MMC packet, into the channel allocation message WCTA.

When the host driver 21 transmits the user data DATA to the wireless USB device, the user data DATA is sent to the EP controller and inserted into the channel allocation message WCTA when the MMC packet is generated, such that the user data DATA inserted into the channel allocation message WCTA can be transmitted thereto. On the other hand, when the host driver 21 receives the user data DATA from the wireless USB device, the user data DATA is also inserted into the MMC packet when the MMC packet is generated, such that the user data DATA inserted into the MMC packet can be received.

Next, the wireless USB DRD system plays the role of the device as follows.

First, the MMC controller 31 receives a packet from the EP controller 35. If the received packet is the MMC packet, the MMC controller 31 extracts the channel allocation message WCTA from the MMC packet. Then, the MMC controller 31 transmits the channel allocation message WCTA to the schedule controller 33 while activating the schedule controller 33.

The DN packet controller 34 receives the DN packet from the device driver 22 or generates the DN packet by itself and sends it to the EP controller 35 in order to transmit the DN packet to the wireless USB host.

After receiving the setup information from the MMC controller 31, the device driver 22 analyzes the setup information SETUP when the MMC controller 31 generates the setup interrupt.

In the case where the setup data SETUP_D is received from the wireless USB host, it is determined whether or not the setup data SETUP_D is received through the EP controller 35. When the setup data is received through the EP controller 35, the setup data SETUP_D is processed.

In the case where the setup data is transmitted to the wireless USB host, the setup data SETUP_D is sent to the EP controller 35.

Further, if the user data DATA to be transmitted to the wireless USB host is present, the device driver 22 sends the user data DATA to the EP controller 35. On the other hand, if data to be received from the wireless USB host is present, the device driver 22 waits for the data from the EP controller 35 and processes the data from the EP controller 35 when receiving the data.

As described above, the present invention provides a wireless USB DRD system in which a common part shared between the wireless USB host and the wireless USB device is extracted from the CPU to implement a wireless USB DRD, and is driven to allow distributed processing independent of the CPU according to roles to reduce system load, so that DRD performance can be improved.

Although the exemplary embodiments of the invention have been illustrated with reference to the accompanying drawings, the present invention is not limited to the embodiments and the drawings. It should be understood that various modifications, changes, and substitutions can be made by those skilled in the art without departing from the spirit and scope of the present invention as disclosed in the accompanying claims.

What is claimed is:

1. A wireless universal serial bus (USB) dual role device (DRD) system playing dual roles of a wireless USB host and a wireless USB device, comprising:
a CPU comprising a host driver for driving as a role of the wireless USB host and a device driver for driving as a role of the wireless USB device; and
a wireless USB DRD controller connected to the CPU through a system bus and accessing a physical layer to extract a channel allocation message and setup information from a micro-scheduled management command (MMC) packet input from the system bus or the physical layer such that the wireless USB DRD controller can be activated to play the role of the host along with the host driver or activated to play the role of the device along with the device driver according to role control and schedule information of the extracted channel allocation message.

2. The wireless USB DRD system according to claim 1, wherein the wireless USB DRD controller comprises:
a role controller outputting a role signal for controlling the wireless USB DRD system to play the role of the host or the device for a predetermined period of time;
an MMC controller extracting and outputting the channel allocation message and the setup information from the MMC packet output from the host driver or an EP controller according to the role signal output from the role controller;
a schedule controller receiving the channel allocation message from the MMC controller and the role signal from the role controller to control transmission/reception schedules;
the EP controller accessing the physical layer to control transmission/reception of user data and a DN packet according to the role signal from the role controller and a control signal from the schedule controller; and
a DN packet controller sending the DN packet output from the EP controller to the host driver and sending the DN packet output from the device driver to the EP controller according to the role signal of the role controller.

3. The wireless USB DRD system according to claim 2, wherein the MMC controller generates and sends a setup interrupt to the device driver when the setup information is extracted.
